(19) United States
(12) Patent Application Publication
(10) Pub. No.: US 2026/0121872 A1
(43) Pub. Date: Apr. 30, 2026

(54) METASTABLE LOGIC-BASED PHYSICAL UNCLONNABLE FUNCTION (PUF) CIRCUITS WITH TRIMMABLE SOURCE DEGENERATION AND ENHANCED AGING PERFORMANCE

(71) Applicant: XILINX, INC., San Jose, CA (US)

(72) Inventors: Aswani Aditya Kumar TADINADA, Hyderabad (IN); Venkatasuryam Setty ISSA, Hyderabad (IN); Chiragkumar Mansukhbhai SENJALIYA, Hyderabad (IN); Ratti Vijay KUMAR, Hyderabad (IN); Divya Krishna KATTA, Hyderabad (IN); Shadi BARAKAT, Redwood City, CA (US)

(21) Appl. No.: 18/933,979

(22) Filed: Oct. 31, 2024

(51) Int. Cl. H04L 9/32; G11C 16/04

(52) U.S. Cl. CPC H04L 9/3278; G11C 16/0483

(57) ABSTRACT

A metastable logic-based physical unclonable function (PUF) circuit with trimmable source degeneration and enhanced aging performance includes metastable logic that generates metastable states at first and second outputs, which settle into respective determinable logic states based on random process variations of elements of the metastable logic. The PUF circuit further includes compensation circuitry to compensate for load mismatches of the first and second outputs. The PUF circuit may further include trimmable (e.g., selectable) source degeneration resistors for controlling voltages of transistors of the metastable logic. Varying numbers of source degeneration resistors may be selected to control the determinable logic state and/or to evaluate the PUF circuit for stability. The source degeneration resistors may also serve a power gates to disable the PUF circuit when not in use, which may reduce age-related effects.

### TECHNICAL FIELD

Examples of the present disclosure generally relate to metastable logic-based physical unclonable function (PUF) circuits with trimmable source de-generation and enhanced aging performance.

### BACKGROUND

A physical unclonable function (PUF) circuit generates an output having a characteristic (e.g., a logic state or a frequency) that is based on inherent/random variations in a fabrication process (i.e., random process variations). Although the output is based on random process variations, if the random process variations are sufficiently pronounced, the output is determinable (i.e., consistent/repeatable). Outputs of multiple PUF circuits may differ from one another due to differing random process variations. The outputs of multiple PUF circuits may thus be combined to generate unique a signature, which may be useful for security/authentication purposes.

Example random process variations include, without limitation, dopant fluctuation, line-edge roughness, and random telegraph noise. Impacts of random process variations may be more pronounced at smaller process scales, where variations become a larger percentage of lengths/widths of integrated circuits. Random process variations may be independent and uncorrelated across devices and/or within a device.

The determinable nature of a PUF circuit may be impacted by a variety of factors, such as external sources of entropy (i.e., capacitive/inductive load mismatches), supply voltage/IR drops, age, and/or environmental conditions (e.g., temperature).

### SUMMARY

Techniques for metastable logic-based physical unclonable function (PUF) circuits with trimmable source de-generation and enhanced aging performance are described.

One example is an integrated circuit device that includes a physical unclonable function (PUF) circuit. The PUF circuit includes metastable logic that generates metastable states at first and second outputs, and permits the first and second outputs to settle into respective determinable logic states based on random process variations of elements of the metastable logic. The PUF circuit further includes compensation circuitry configured to compensate for load mismatches of the first and second outputs.

Another example is an integrated circuit device that includes a PUF circuit, where the PUF circuit includes metastable logic that generates metastable states at first and second outputs and permits the first and second outputs to settle into respective determinable logic states based on random process variations of elements of the metastable logic, and where the metastable logic includes first and second logic gates configured as a locked latch. The PUF circuit further includes first and second voltage control circuits (e.g., banks of source degeneration resistors) configured to control supply voltages of transistors of respective ones of the first and second logic gates.

Another example is a method that includes activating metastable logic of a physical unclonable function (PUF) circuit to generate metastable states at first and second outputs of the metastable logic, coupling the first and second outputs to one another for a delay period to retain the first and second outputs at the metastable states for the delay period, de-coupling the first and second outputs from one another subsequent to the delay period, permitting the first and second outputs to settle into respective determinable logic states based on random process variations of elements of the metastable logic, and outputting a PUF logic state based on the logic state of one or more of the first and second outputs of the metastable logic.

The method may further include enabling differing numbers of the resistors of first and second voltage control circuits to alter the determinable states of the first and second outputs.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a physical unclonable function (PUF) circuit that includes metastable logic and compensation circuitry, according to an embodiment.

FIG. 2 depicts a system that includes an integrated circuit having multiple PUF circuits and a signature generator circuit, according to an embodiment.

FIG. 3 depicts an integrated circuit device that includes the PUF circuit of FIG. 1, where the metastable logic includes a locked set-reset (SR) latch, according to an embodiment.

FIG. 4 depicts the integrated circuit device of FIG. 3, in which the compensation circuitry includes a switch having terminals coupled to outputs of the metastable logic, according to an embodiment.

FIG. 5 depicts the integrated circuit device of FIG. 4, in which the switch includes pass gate transistors, according to an embodiment.

FIG. 6 is a schematic diagram of a switch control circuit, according to an embodiment.

FIG. 7 depicts timing diagrams for the switch control circuit, according to an embodiment.

FIG. 8 depicts the integrated circuit device of FIG. 3, in which the compensation circuitry includes NAND gates that logically NAND the outputs of the metastable logic with an enable control, according to an embodiment.

FIG. 9 is a schematic diagram of the PUF circuit, as depicted in FIG. 8, according to an embodiment.

FIG. 10 depicts the integrated circuit device of FIG. 3, further including voltage control circuits that regulate supply voltages of the metastable logic, according to an embodiment.

FIG. 11 is a schematic of a NAND gate of the metastable logic and a corresponding one of the voltage control circuits, according to an embodiment.

FIG. 12 depicts a code translator for a voltage control circuit of FIG. 10, according to an embodiment.

FIG. 13 is a schematic of the voltage control circuit of FIG. 10, according to an embodiment.

FIG. 14 is a schematic of the voltage control circuit of FIG. 10, according to another embodiment.

FIG. 15 is a schematic of the voltage control circuit of FIG. 10, according to another embodiment.

FIG. 16 is a schematic of the voltage control circuit of FIG. 10, according to another embodiment.

FIG. 17 depicts the PUF circuit of FIG. 1, further including a switch, NAND gates, and voltage control circuits, according to an embodiment.

FIG. 18 depicts a method of generating a determinable bit value based on random process variations of a PUF circuit, according to an embodiment.

FIG. 19 depicts a method of evaluating a PUF circuit for stability, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe metastable logic-based physical unclonable function (PUF) circuits with trimmable source de-generation and enhanced aging performance

In the generation of true random number, all sources of systematic/deterministic errors should be annulled in the circuit. Typical sources of errors include mismatch in load at output nodes, mismatch in supply due to IR drop. Some of these issues like IR drop, routing capacitance mismatches can be minimized with proper attention to layout. The current idea further improves the uniformity in distribution of 1's and 0's by nullifying the impact of systematic load mismatch. A switch is placed to short the outputs of the latch and force it to stay in meta-stable state. Any difference in load conditions (routing capacitance etc. . . . ) of the latch is effectively annulled by initializing these capacitors to same voltage. Additionally, the switch helps to bring the latch to a meta-stable state where regeneration happens primarily by amplification of MOS mismatch.

After manufacture, a standard latch circuit, whose value was decided due to inherent mismatch, can flip its state due to change in supply voltage, temperature, and aging if the amount of MOS mismatch is small. Generally, 40% or more latch cells are not robust and need to be identified/filtered. The trimmed source de-generation resistor is added to PMOS in NAND gates, this introduces systematic mismatch into the latch cell. The amount of systematic mismatch required for bit flipping is the measure of robustness. The cells which require less systematic mismatch for bit flipping are identified and filtered after fabrication to identify robust cells which can be used as PUF for security of the chip.

Degradation due to aging can also flip the state of latch cells in PUF. Generally, PUF cells are read during chip boot time and remaining time they are disabled. For this use case aging degradation is primarily caused by NBTI and PBTI. The trimmed source de-generation resistor on PMOS in NAND which is implemented using MOS will act as a power gate to cut off the supply for latch cell when not in use there by removing NBTI and PBTI aging effects. Since activity of security IP is less than 1% of the time, having this power switch for the latch drastically improves the lifetime of the PUF.

A PUF circuit, as disclosed herein, includes metastable logic that generates metastable states at first and second outputs, and permits the first and second outputs to settle into respective determinable logic states based on random process variations of elements of the metastable logic. The metastable logic may include a locked latch, such as a locked set-reset (SR) latch.

A PUF circuit, as disclosed herein, may further include compensation circuitry. The compensation circuitry may include a switch that annuls systematic load mismatch at outputs of the locked latch. The compensation circuitry may include NAND gates that isolate outputs of the locked latch from external load mismatches.

The compensation circuitry may include voltage control circuits having respective banks of trimmable resistors to control supply voltages of transistors of respective logic gates of the locked latch. The voltage control circuits may include degeneration resistors that alter effects of random process variations of the transistors of the metastable logic. Various combinations of the resistors may be selected/enabled to screen the PUF circuit for robustness. The resistors may be deselected/disabled after the outputs settle into the determinable logic states (e.g., power-gating to enhance aging performance). The voltage control circuits may be set to differing voltage levels (e.g., to alter the determinable logic states of the outputs).

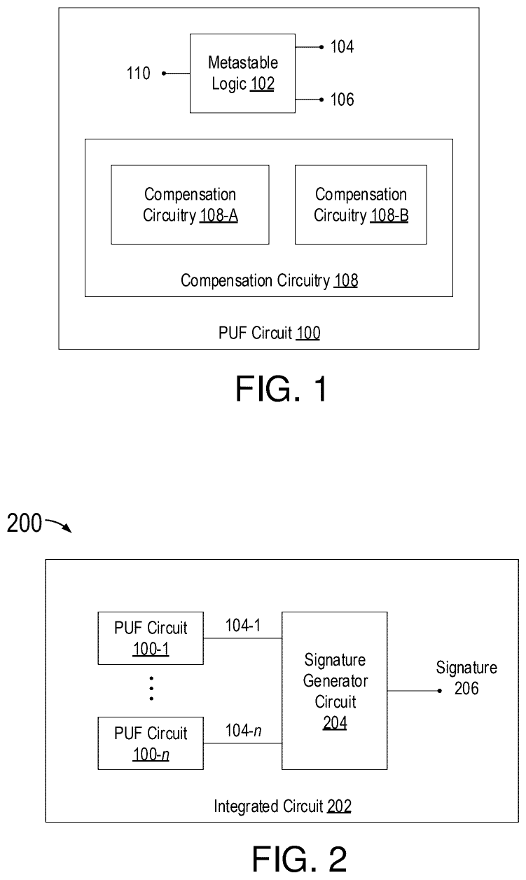

FIG. 1 depicts a physical unclonable function (PUF) circuit 100 that includes metastable logic 102, according to an embodiment. Metastable logic 102 generates or establishes metastable states at outputs 104 and 106, and permits the metastable states to (consistently) settle into (respective first and second) determinable logic states based on random process variations of elements of metastable logic 102. In digital logic circuits, a digital signal is to be within certain voltage or current limits to represent a ‘0’ or ‘1’ logic level. Where a logic one is defined as a source voltage (e.g., VDD), and a logic zero is defined as a reference voltage (e.g., VDD or ground), a metastable state is between the source voltage and the reference voltage. Although the settled states of outputs 104 and 106 are determined by random process variations, the random process variations generally remain fixed over time. The settled states of outputs 104 and 106 are thus determinable. Metastable logic 102 may generate or establish the metastable states when power is applied and/or when stimulated with an input 110.

The determinable nature of PUF circuit 100 may be impacted by systematic/deterministic errors, capacitive/inductive load mismatches at outputs 104 and 106, which may be due to random process variations in fanout circuits and/or capacitive routing mismatches, mismatches in supply voltages due to voltage/IR drops, and/or age. It may be useful to compensate for such systematic/deterministic errors. In FIG. 1, PUF circuit 100 further includes compensation circuitry 108 that compensates for systematic/deterministic errors, capacitive/inductive load mismatches at outputs 104 and 106, mismatches in supply voltages due to voltage/IR drops, and/or age. In the example of FIG. 1, compensation circuitry 108 includes compensation circuitry 108-A and 108-B, examples of which are provided further below.

FIG. 2 depicts a system 200 that includes an integrated circuit 202 having multiple PUF circuits 100-1 through 100-n, according to an embodiment. PUF circuits 100-1 through 100-n include respective outputs 104-1 through 104-n. When power is applied to PUF circuits 100-1 through 100-n, or when a stimulus is applied, outputs are initially at metastable states, and each output 104-1 through 104-n settles into one of two logic states based on random process variations of the respective PUF circuits 100-1 through 100-n.

Integrated circuit 202 further includes a signature generator circuit 204 that generates a signature 206 based on outputs 104-1 through 104-n of PUF circuits 100-1 through 100-n. Signature 206 is unique to integrated circuit 202, based on the random process variations of PUF circuits 100-1 through 100-n.

Signature 206 may be useful to authenticate integrated circuit 202 to another integrated circuit of system 200 (e.g., a platform management controller and/or a trusted execution unit), and/or to authenticate system 200 to another system (e.g., a host device and/or a network-connected device). As an example, and without limitation, system 200 may represent a user device (e.g., smart phone) or an Internet-of-Things (IoT) device, and signature generator circuit 204 may provide signature 206 to a management system/server (e.g., via the Internet) for authentication of the user device.

Metastable logic 102 may include, for example and without limitation, a latch circuit (e.g., a locked flip-flop), such as an asynchronous set-reset (SR) latch for which set and reset terminals are coupled to one another (i.e., a locked SR latch), an example of which is provided below.

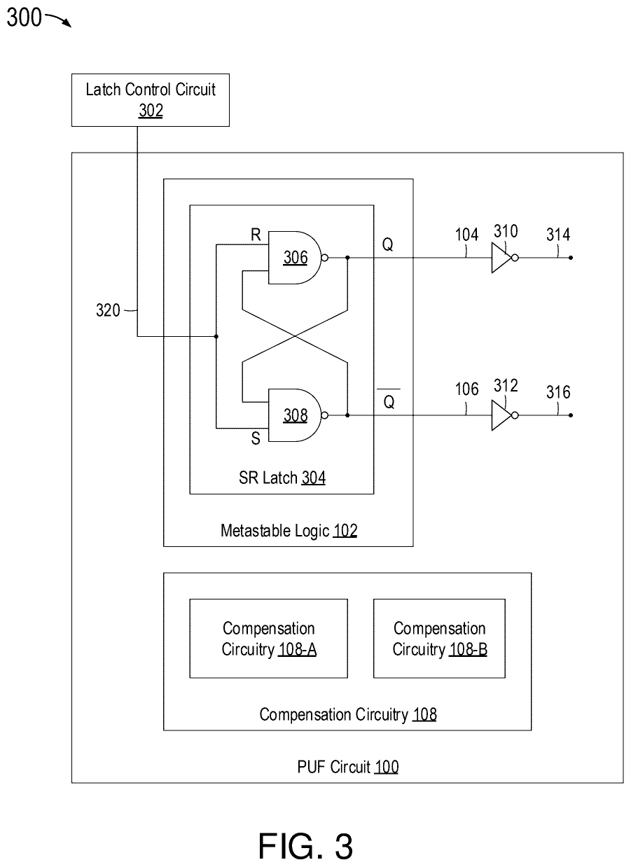

FIG. 3 depicts an integrated circuit device 300, in which metastable logic 102 includes a locked SR latch 304, according to an embodiment. SR latch 304 includes a pair of cross-coupled logic gates (e.g., NAND or NOR or AOI logic gates), depicted here as NAND gates 306 and 308, designed to maintain/output opposite logic states, Q and Q̅, where Q≠Q̅. SR latch 304 further includes set and reset inputs, S and R. Normally, setting S=1 and R=0 sets Q=1, and setting S=0 and R=1 resets Q=0. Setting S=R=1 is normally considered improper, as it results in contention between the cross-coupled logic gates (i.e., a metastable state).

In FIG. 3, inputs S and R are coupled together to provide a locked SR latch. In this example, a latch control circuit 302 may stimulate metastable logic 102 by pulling up a control 320, such that S=R=1. In this situation, outputs 104 and 106 may initially be at metastable states. Absent random process variations, the probability of Q settling to 1 or 0 is 50%. Due to differences in random process variations between NAND gates 306 and 308, Q may consistently settle to 1, or may consistently settle to 0. As an example, the random process variations may impact voltage thresholds of the transistors such one of NAND gates 306 and 308 produces the respective output faster and/or stronger than the other NAND gate, which overcomes the contention and results in outputs 104 and 106 consistently settling into the same (opposite) logic states.

PUF circuit 100 may further include inverters 310 and 312 to invert outputs 104 and 106 as outputs 314 and 316.

As noted further above, outputs 104 and 106 may be impacted by capacitive and/or inductive load mismatches. As an example, outputs 104 and 106 may be coupled to other circuitry (e.g., inverters 310 and 312 and/or other circuitry). Random process variations of the other circuitry (e.g., transistor gate capacitance mismatches between inverters 310 and 312) and/or routing differences between outputs 104 and 106 and the other circuitry, may introduce undesired sources of entropy/randomness to the determinable states of outputs 104 and 106. Compensation circuitry 108 may compensate for capacitive load mismatches and/or other issues, such as described in examples below. In the examples below, metastable logic 102 includes locked SR latch 304. The examples below are not limited to locked SR latch 304.

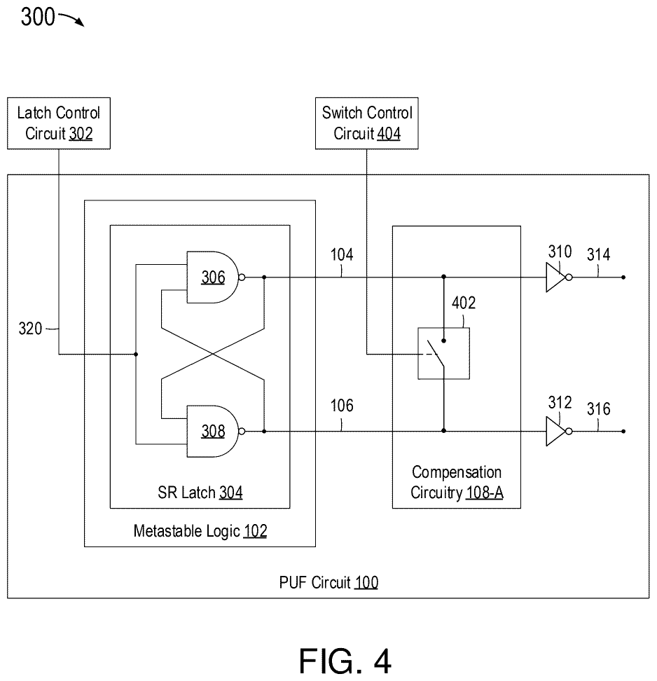

FIG. 4 depicts integrated circuit device 300 in which compensation circuitry 108-A includes a switch 402 having terminals coupled to outputs 104 and 106, according to an embodiment. In this example, a switch control circuit 404 may briefly close switch 402, while control 320 is asserted, to retain outputs 104 and 106 in a metastable state for a period of time, and may thereafter open switch 402 to permit outputs 104 and 106 to settle into respective determinable logic states. Closing switch 402 while control 320 is asserted may annul any external capacitive mismatch by initializing the external capacitances to same voltage. Closing switch 402 while control 320 is asserted may thus help to insure that the determinable states of outputs 104 and 106 are based primarily or solely due to random process variations of metastable logic 102. Switch 402 may also be useful to bring outputs 104 and 106 to the metastable state when used in combination with degeneration resistors that alter transistor mismatches within metastable logic 102, such as described further below. Switch control circuit 404 may be placed physically proximate to switch 402 (e.g., within compensation circuitry 108-A).

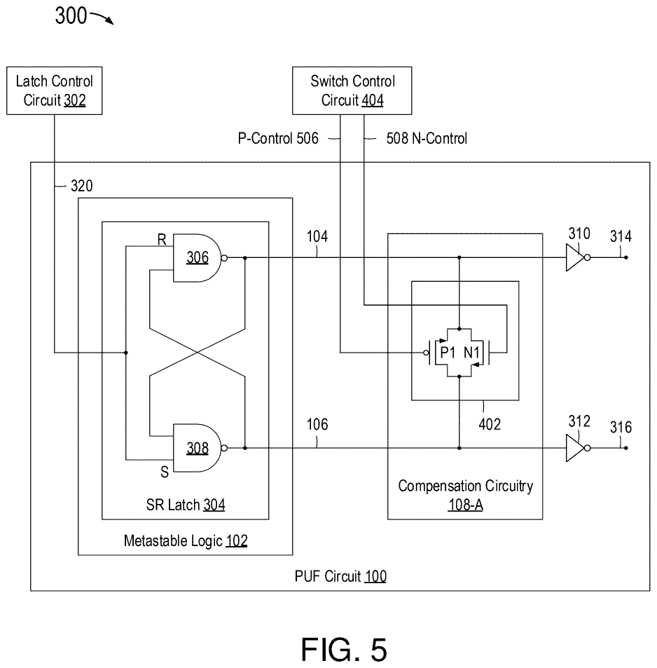

FIG. 5 depicts integrated circuit device 300 in which switch 402 includes pass gate transistors, N1 and P1, according to an embodiment. In the example of FIG. 5, switch control circuit 404 controls pass gates N1 and P1 with P-control 506 and N-control 508, respectively.

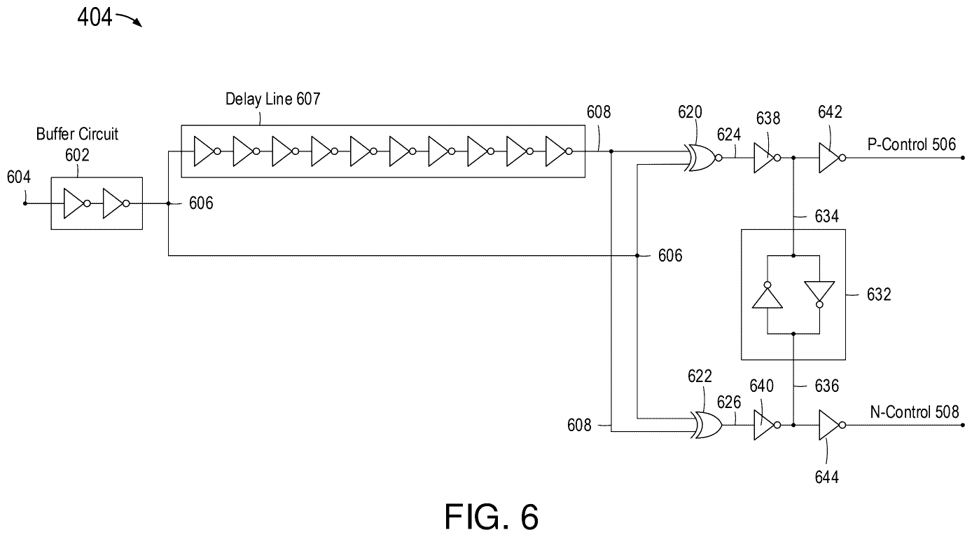

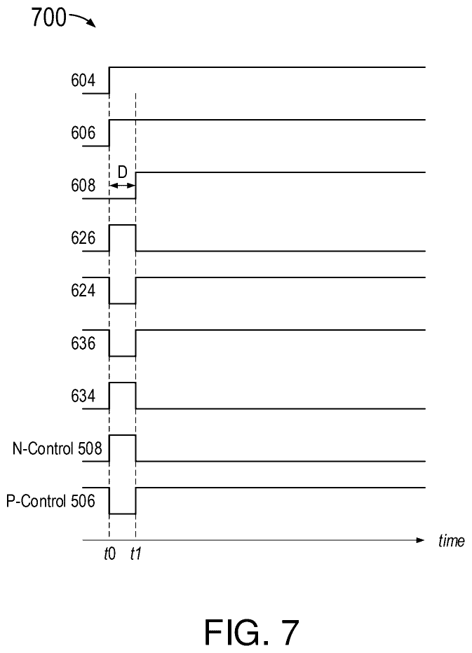

FIG. 6 is a schematic diagram of switch control circuit 404, according to an embodiment. FIG. 7 depicts timing diagrams for switch control circuit 404, as depicted in FIG. 6, according to an embodiment. In FIG. 6, switch control circuit 404 includes a buffer circuit 602 that buffers an input 604 (e.g., control 320). Switch control circuit 404 further includes a delay line 607 that delays an output 606 of buffer circuit 602 by a delay D. Switch control circuit 404 further includes an XNOR gate 620 and a XOR622 that receive output 606 of buffer circuit 602 and an output 608 of delay line 607. Switch control circuit 404 further includes an inverter 638 that inverts an output 624 of XNOR gate 620, and an inverter 640 that inverts an output 626 of XOR gate 622. Switch control circuit 404 further includes a cross-coupled inverter circuit 632 that maintains logic states of outputs 634 and 636 of inverters 638 and 640 (e.g., analogous to a memory cell). Switch control circuit 404 further includes an inverter 642 that inverts output 634 to provide P-control 506, and an inverter 644 that inverts output 636 to provide N-control 508.

As depicted in FIG. 7, input 604 is pulled up at time to. Output 608 of delay line 607 is pulled up following delay D. During delay D, output 624 of XNOR gate 620 is pulled down, output 626 of XOR gate 622 is pulled up, output 634 of inverter 638 is pulled up, and output 636 of inverter 640 is pulled down. In this state, P-control 506 is pulled down and N-control 508 is pulled up, to close switch 402 (i.e., as depicted in FIG. 5). At the end of delay D (i.e., time t1), output 634 of inverter 638 is pulled down, and output 636 of inverter 640 is pulled up. In this state, P-control 506 is pulled up and N-control 508 is pulled down, to open switch 402.

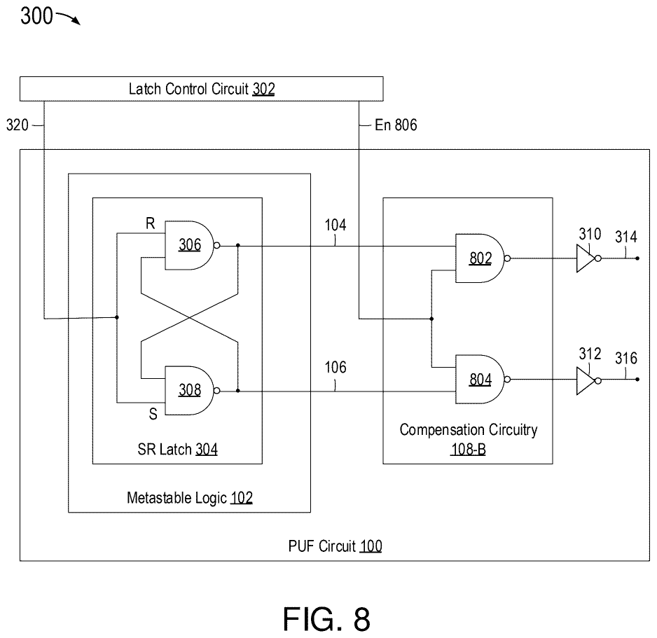

FIG. 8 depicts integrated circuit device 300 in which compensation circuitry 108-B includes NAND gates 802 and 804 that logically NAND outputs 104 and 106 with an enable control 806, according to an embodiment. Latch control circuit 302 may activate enable control 806 in tandem with control 320. NAND gates 802 and 804 may be useful to isolate metastable logic 102 from load mismatches/external sources of entropy.

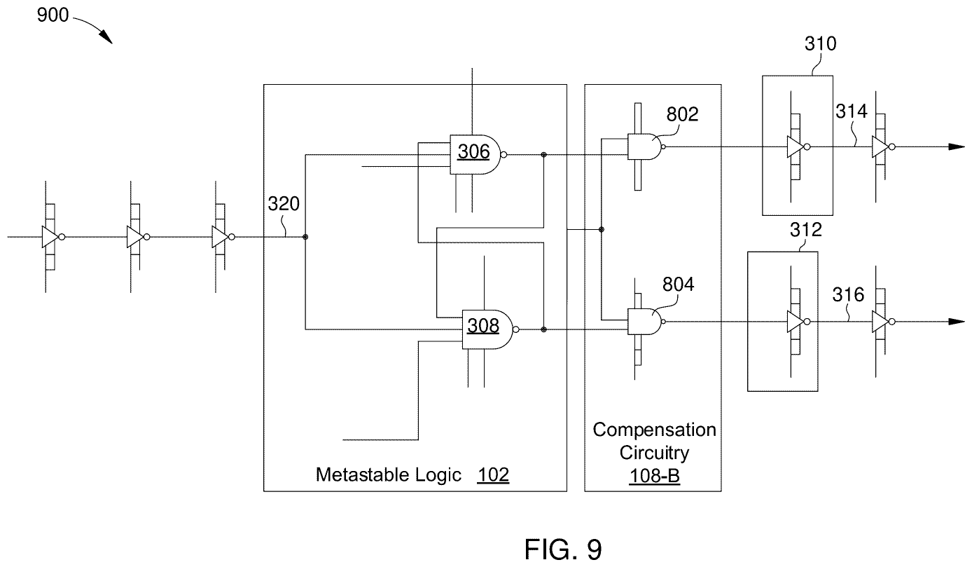

FIG. 9 is a schematic diagram 900 of PUF circuit 100, as depicted in FIG. 8, according to an embodiment.

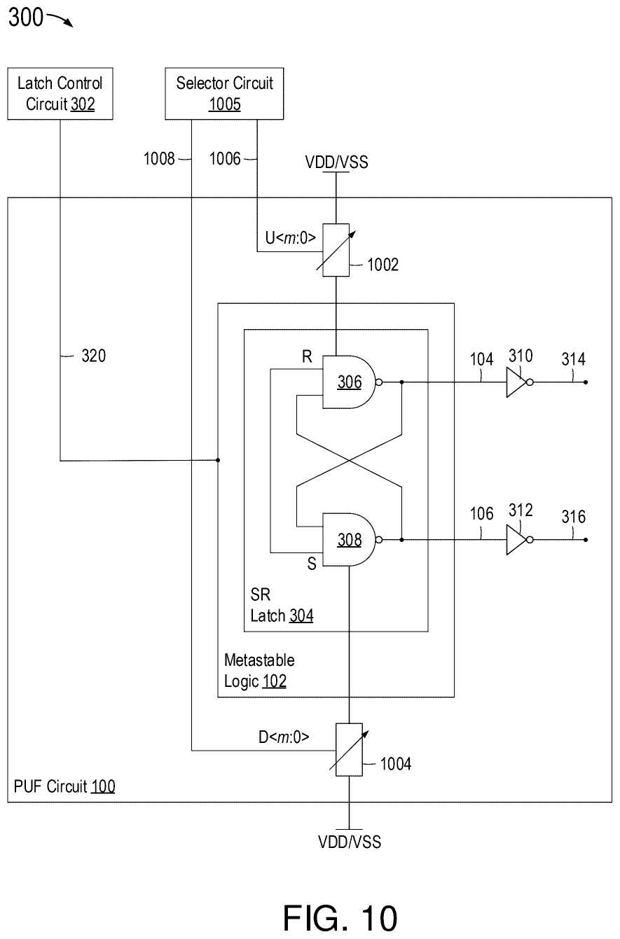

FIG. 10 depicts integrated circuit device 300, further including voltage control circuits 1002 and 1004 that regulate supply voltages of metastable logic 102, according to an embodiment. Voltage control circuits 1002 and 1004 may considered part of compensation circuitry 108. Voltage control circuits 1002 and 1004 may include variable resistances (e.g., selectable resistors). A selector circuit 1005 may control voltage control circuits 1002 and 1004 with respective multi-bit control words 1006 (e.g., U<m:0>) and 1008 (e.g., D<m:0>), where m is a positive integer. In an example, m equals 3 (i.e., 4-bit control words).

Voltage control circuits 1002 and 1004 may include trimmable source degeneration resistors (e.g., for PMOS transistors of NAND gates 306 and 308), which may introduce and/or alter systemic mismatches amongst transistors of metastable logic 102. Trimmable source degeneration resistors may be useful to ensure that outputs 104 and 106 are determinable, and that the determinable nature of outputs 104 and 106 is due primarily to random process variations of metastable logic 102.

Voltage control circuits 1002 and 1004 may be useful to screen for marginal PUF circuits (i.e., PUF circuits having insufficiently determinable outputs), post-fabrication. In some situations, mismatches in random process variations within metastable logic 102 are relatively small, such that the settled states of outputs 104 and 106 may change under differing conditions (e.g., changes in supply voltages, temperature, and/or age). In such a situation, outputs 104 and 106 may be insufficiently determinable for use in signature 206 of FIG. 2. To detect such marginal PUF circuits, selector circuit 1005 may exercise PUF circuits 100-1 through 100-n (FIG. 2) by uniformly sweeping through a range of values of control word 1006 and/or control word 1008. If the output 104 of any of PUF circuits 100-1 through 100-n changes during the sweep, the PUF circuit may be deemed insufficiently determinable for use in signature 206. PUF circuits that require less systematic mismatch for bit flipping may be identified and filtered after fabrication. Remaining PUF circuits may be selected for signature 206 in FIG. 2. In other words, trimmable source degeneration resistors may be useful in screening PUF circuits, where the amount of systematic mismatch required for bit flipping may serve as a measure of robustness.

Voltage control circuits 1002 and 1004 may be useful to reduce impacts of age. Impacts of random process variations may vary over time, which may render outputs 104 and 106 insufficiently determinable over time. In many situations, PUF circuits are read during boot time, and are un-used thereafter. In such situations, age-based degradation is primarily due to negative bias temperature instability (NBTI) and positive bias temperature instability (PBTI). Selector circuit 1005 may reduce impacts of age by disabling voltage control circuits 1002 and 1004 when unneeded (e.g., subsequent to generating signature 206 in FIG. 2). In this example, voltage control circuits 1002 and 1004 may serve as power gates.

Voltage control circuits 1002 and 1004 may be useful to intentionally alter the determinable states of outputs 104 and 106. As an example, selector circuit 1005 may set control words 1006 and 1008 to different values to alter the impact (i.e., weights) of the random process variations of NAND gates 306 and 308, relative to one another, so change the determinable states of outputs 104 and 106. This may be useful to permit a user to alter signature 206 (e.g., for enhanced authentication security).

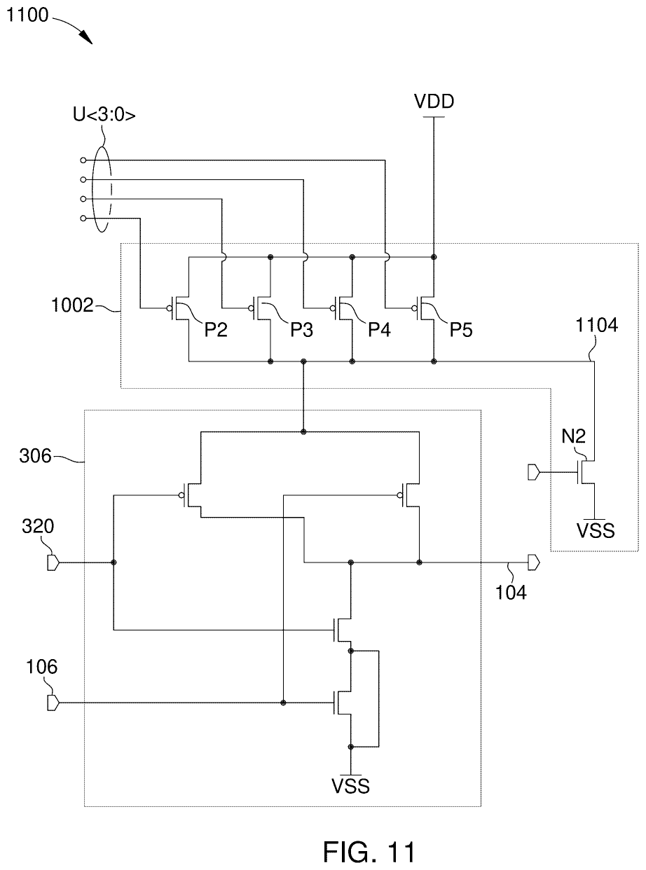

FIG. 11 is a schematic of NAND gate 306 and voltage control circuit 1002, according to an embodiment. In the example of FIG. 11, voltage control circuit 1002 includes four P-type transistors, P2, P3, P4, and P5, that serve as selectable resistors. Selector circuit 1005 may enable various combinations of the resistors via controls U<3:0>. Voltage control circuit 1002 may further include power-down device, depicted here as an N-Type transistor N2, which may be activated in a power-down mode to pull down a supply voltage node 1104 of NAND gate 306, which may be useful to reduce NBTI and PBTI effects. The source degeneration resistor essentially adds negative feedback. NAND gate 308 and voltage control circuit 1004 may be similar or identical to NAND gate 306 and voltage control circuit 1002.

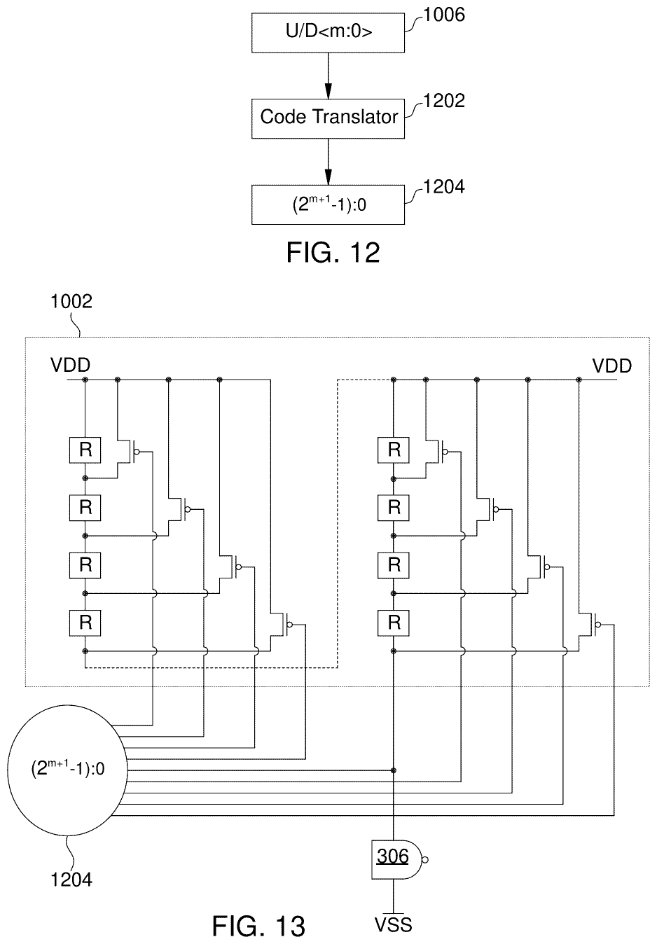

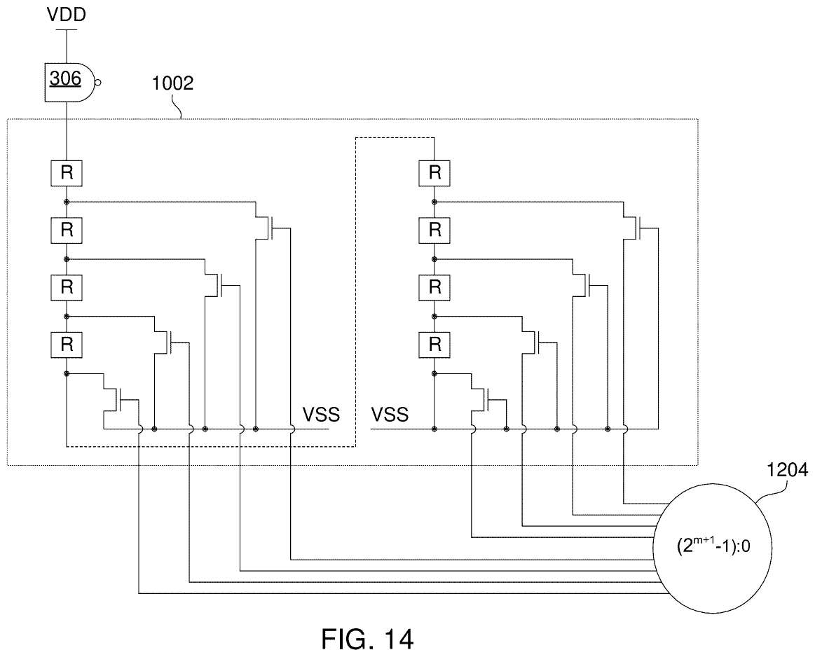

Selector circuit 1005 may further include code translators to control voltage control circuits 1002 and 1004, such as described below with reference to FIGS. 12 through 14. FIG. 12 depicts a code translator 1202, according to an embodiment. Code translator 1202 translates control word 1006 into a code 1204. Code translator 1202 and/or another code translator may translate control word 1008 in a similar fashion. FIG. 13 is a schematic of voltage control circuit 1002, according to an embodiment. In the example of FIG. 13, voltage control circuit 1002 includes selectable series-coupled resistors R controlled by code 1204 and P-type pull-up transistors. FIG. 14 is a schematic of voltage control circuit 1002, according to another embodiment. In the example of FIG. 14, voltage control circuit 1002 includes selectable series-coupled resistors R controlled by code 1204 and N-type pull-down transistors.

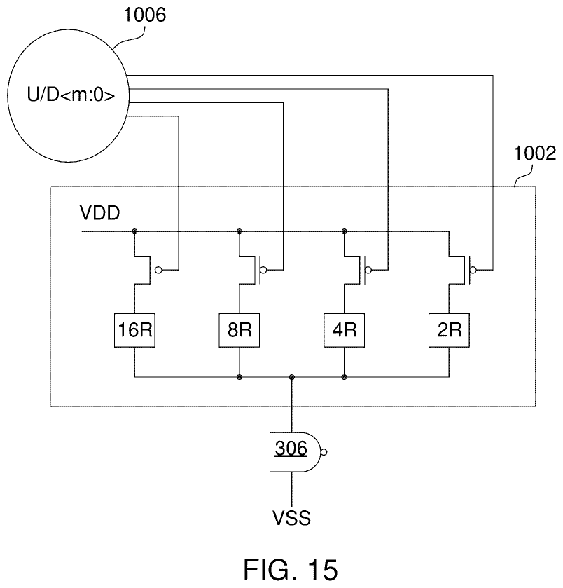

FIG. 15 is a schematic of voltage control circuit 1002, according to another embodiment. In the example of FIG. 15, voltage control circuit 1002 includes parallel selectable resistors controlled by control word 1006, where each resistor is coupled in series with a P-type pull-up transistor.

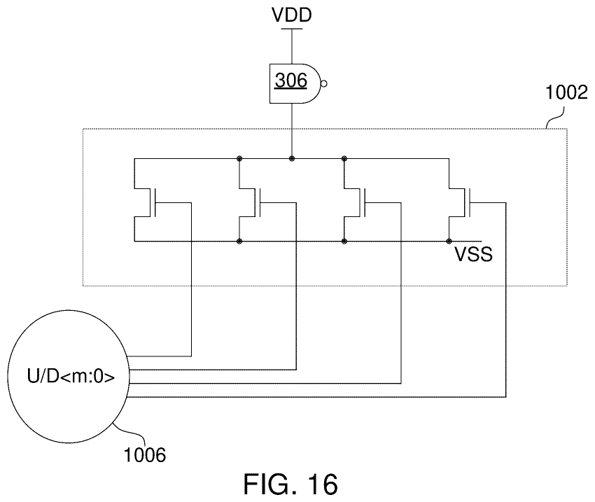

FIG. 16 is a schematic of voltage control circuit 1002, according to another embodiment. In the example of FIG. 16, voltage control circuit 1002 includes parallel selectable resistors controlled by control word 1006, where each resistor is coupled in series with a N-type pull-down transistor.

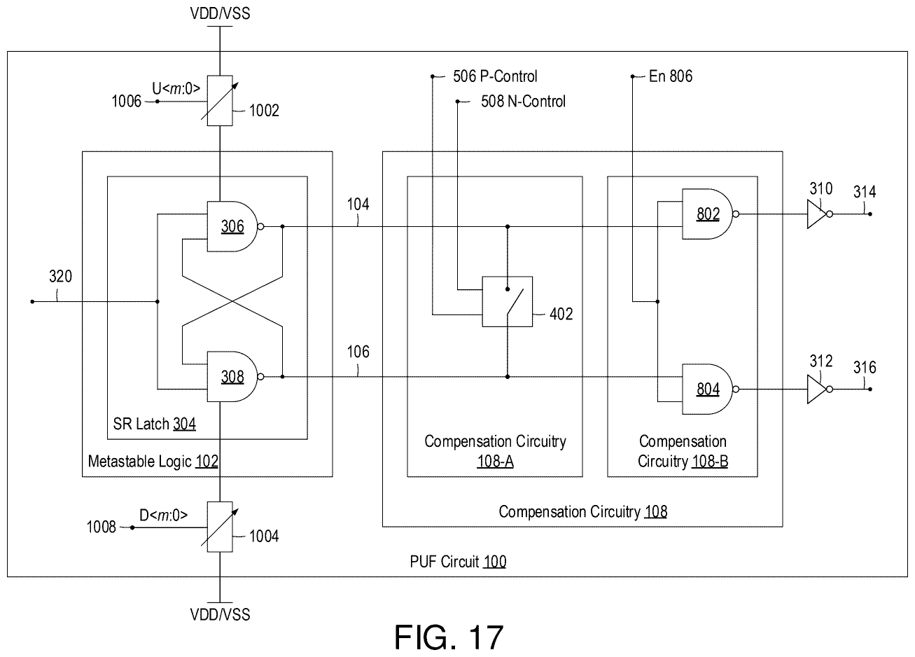

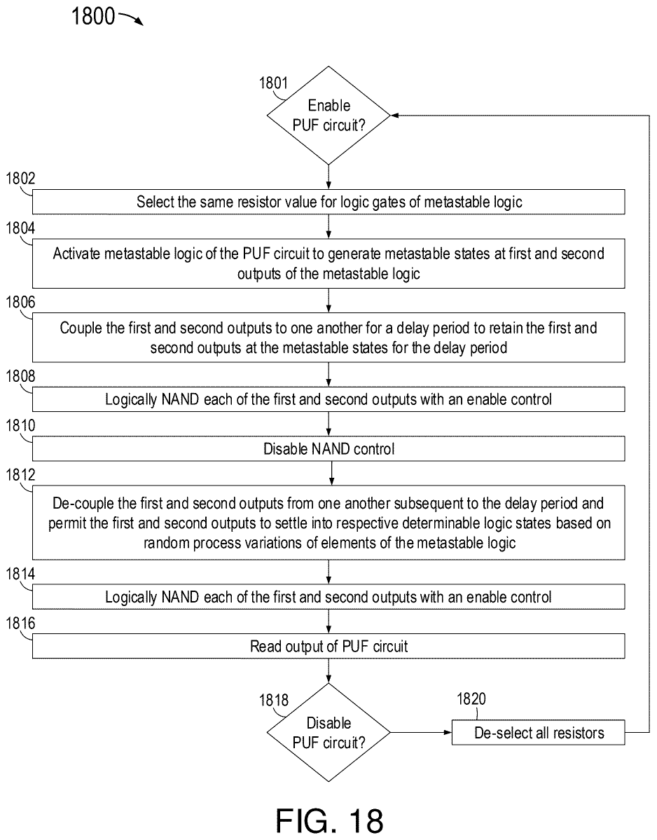

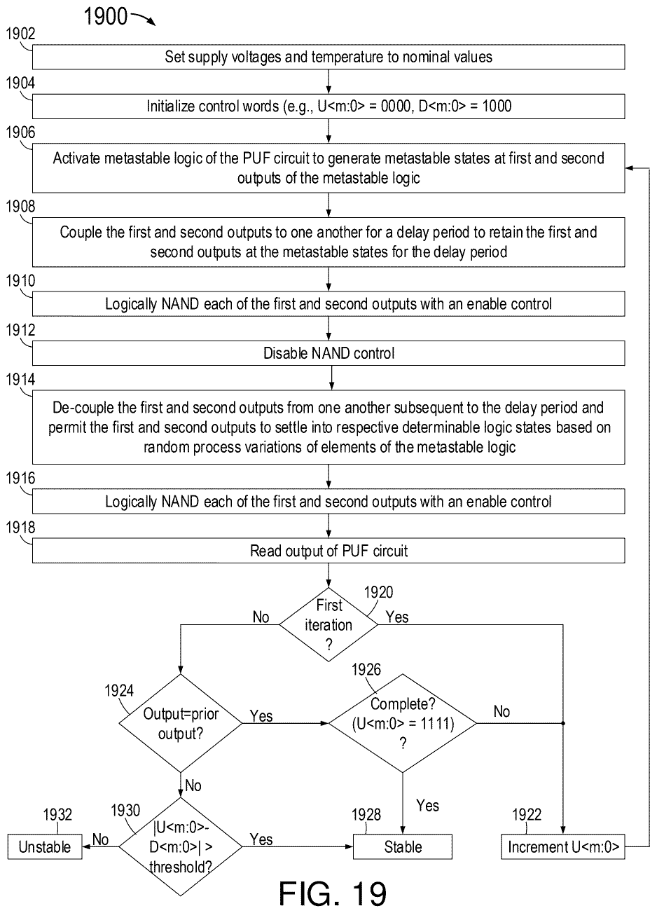

A PUF circuit may include various combinations of switch 402, NAND gates 802 and 804, and/or voltage control circuits 1002 and 1004. FIG. 17 depicts PUF circuit 100, further including switch 402, NAND gates 802 and 804, and voltage control circuits 1002 and 1004, according to an embodiment. FIG. 17 is described below with reference to FIGS. 18 and 19.

FIG. 18 depicts a method 1800 of generating a determinable bit value based on random process variations of a PUF circuit, according to an embodiment. Method 1800 is described below with reference to FIGS. 1 through 17. Method 1800 is not limited to the examples of FIGS. 1 through 17.

At 1801, when PUF circuit 100 is to be enabled, processing proceeds to 1802. PUF circuit 100 may be enabled on power-up and/or subsequent to power-up.

At 1802, selector circuit 1005 sets a resistance (selects a number of resistors) of voltage control circuits 1002 and 1004 with control words 1006 and 1008. In the example of FIG. 18, selector circuit 1005 may set control words 1006 and 1008 equal to one another to provide the same nominal voltage to NAND gates 306 and 308.

At 1804, metastable logic 102 is activated to generate metastable states at outputs 104 and 106. In FIG. 3, latch control circuit 302 pulls up control 320 to activate locked SR latch 304.

At 1806, switch control circuit closes switch 402 to retain outputs 104 and 106 at the metastable states for delay period D.

At 1808, latch control circuit 302 enables NAND gates 802 and 804 (i.e., sets enable control 806 to logic 1) to logically NAND outputs 104 and 106 with enable control 806 to present matching loads on outputs 104 and 106.

At 1810, latch control circuit 302 disables NAND gates 802 and 804 (i.e., sets enable control 806 to logic 0).

At 1812, switch control circuit opens switch 402 to permit outputs 104 and 106 to settle into respective determinable states.

At 1814, latch control circuit 302 enables NAND gates 802 and 804 to logically NAND outputs 104 and 106 with enable control 806.

At 1816, signature generator circuit 204 reads output 314 and/or output 316 of PUF circuit 100.

At 1818, if PUF circuit 100 is to be disabled, processing proceeds to 1820, where selector circuit 1005 disables all resistors of voltage control circuits 1002 and 1004. Processing then returns to 1801.

FIG. 19 depicts a method 1900 of evaluating a PUF circuit for stability, according to an embodiment. Method 1900 is described below with reference to FIGS. 1 through 17. Method 1800 is not limited to the examples of FIGS. 1 through 18.

At 1902, a user and/or a test device sets supply voltages and an environmental temperature of PUF circuit 100 to desired levels.

At 1904, selector circuit 1005 initializes control words 1006 and 1008. In an example, selector circuit 1005 sets control word 1006 to a minimum value and sets control word 1008 to a maximum value (e.g., U<m;0>=0000 and D<m;0>=1111)

At 1906, metastable logic 102 is activated to generate metastable states at outputs 104 and 106, such as described further above with reference to 1804 in FIG. 18

At 1908 switch control circuit closes switch 402 to retain outputs 104 and 106 at the metastable states for delay period D, such as described further above with reference to 1806 in FIG. 18.

At 1910, latch control circuit 302 enables NAND gates 802 and 804 to logically NAND outputs 104 and 106 with enable control 806, such as described further above with reference to 1808 in FIG. 18.

At 1912, latch control circuit 302 disables NAND gates 802 and 804, such as described further above with reference to 1816 in FIG. 18.

At 1914, switch control circuit opens switch 402 to permit outputs 104 and 106 to settle into respective determinable states.

At 1916, latch control circuit 302 enables NAND gates 802 and 804 to logically NAND outputs 104 and 106 with enable control 806.

At 1918, the test device or signature generator circuit 204 reads output 314 and/or output 316 of PUF circuit 100.

At 1920, for a first iteration of method 1900 (e.g., U<m;0>=0000), processing proceeds to 1922, where selector circuit 1005 increments control word 1006. Processing then returns to 1906. For subsequent iterations (e.g., U<m;0>greater than 0000), processing proceeds to 1924.

At 1924, the test device determines whether the state of output 314 and/or output 316 read at 1918 differs from a state of output 314 and/or output 316 read in a prior iteration of method 1900. If the states do not differ, processing proceeds 1926.

At 1926, if control word 1006 is below a maximum value (e.g., U<m;0>=1111), processing proceeds to 1922 where selector circuit 1005 increments control word 1006. Processing then returns to 1906. If control word 1006 has reached a maximum value (e.g., U<m;0>=1111), processing proceeds to 1928, where the test device determines that PUF circuit 100 is stable (i.e., outputs 314 and 316 remain determinable over a range of voltage differences applied to the transistors of NAND gate 306 relative to the voltage applied to the transistors of NAND gate 308).

Returning to 1924, if the state of output 104 and/or output 106 read at 1918 differs from a state of output 104 and/or output 106 read in a prior iteration, processing proceeds to 1930.

At 1930, the test device determines whether a difference between the states/values of control words 1006 and 1008 meets a margin threshold. If the difference does not meet the margin threshold, processing proceeds to 1932, where the test device determines that PUF circuit 100 is unstable (i.e., outputs 104 and 106 remain determinable over a range of voltage differences applied to the transistors of NAND gate 306 relative to the voltage applied to the transistors of NAND gate 308). If the difference meets the margin threshold, processing proceeds to 1928, where the test device determines that PUF circuit 100 is stable (i.e., the difference between control words 1006 and 1008 exceeds a difference. The margin threshold may be set to a level at which the difference between control words 1006 and 1008 would be expected to flip the output states of a stable PUF circuit.

Method 1900 may be repeated for one or more other values/states of control 1008. As an example, at 1904, selector circuit 1005 may initialize control words 1006 and 1008 to minimum values (e.g., U<m;0>=0000 and D<m;0>=0000). In this example, when control word 1006 reaches a maximum value at 1926, selector circuit 1005 may reset control word 1006 to the minimum value, increment control word 1008, and return to 1904, until control word 1008 reaches a maximum value.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit device, comprising:
a physical unclonable function (PUF) circuit comprising,
metastable logic configured to generate metastable states at first and second outputs and to permit the first and second outputs to settle into respective determinable logic states based on random process variations of elements of the metastable logic, and
compensation circuitry configured to compensate for load mismatches of the first and second outputs.

2. The integrated circuit device of claim 1, wherein the metastable logic comprises a set-reset (SR) latch, wherein set and reset terminals of the SR latch are coupled to one another.

3. The integrated circuit device of claim 1, wherein the compensation circuitry comprises:
a switch configured to retain the first and second outputs at the metastable states for a delay period.

4. The integrated circuit device of claim 1, wherein the compensation circuitry comprises:
a switch coupled to the first and second outputs;
a first NAND gate configured to receive the first output and an enable control;
a second NAND gate configured to receive the second output and the enable control; and
control circuitry configured close the switch when the metastable logic is activated to maintain the first and second outputs at a metastable state for a delay period, activate and deactivate the enable control during the delay period, open the switch after the delay period to permit the first and second outputs to settle into the respective determinable logic states, and re-activate the enable control subsequent to the delay period.

5. The integrated circuit device of claim 1, wherein the metastable logic comprises first and second logic gates configured as a locked latch, and wherein the PUF circuit further comprises:
a first voltage control circuit configured to control a voltage of transistors of the first logic gate; and
a second voltage control circuit configured to control a voltage of transistors of the second logic gate.

6. The integrated circuit device of claim 5, wherein the first and second voltage control circuits each comprise:
a bank of selectable source degeneration resistors configured to alter effects of random process variations of the transistors of the respective logic gates.

7. The integrated circuit device of claim 5, wherein the first voltage control circuit comprises a first bank of selectable resistors, wherein the second voltage control circuit comprises a second bank of selectable resistors, and wherein the PUF circuit further comprises:
a selector circuit configured to select resistors of the first and second banks with respective first and second multi-bit words.

8. The integrated circuit device of claim 7, wherein the selector circuit is further configured to:
control the first and second voltage control circuits to provide a same voltage to the transistors of the first and second logic gates.

9. The integrated circuit device of claim 8, wherein the selector circuit is further configured to:
control the first voltage control circuit to vary the voltage provided to the transistors of the first logic gate over a range of supply voltage increments, while providing a constant voltage to the transistors of the second logic gate.

10. An integrated circuit device, comprising:
a physical unclonable function (PUF) circuit comprising,
metastable logic configured to generate metastable states at first and second outputs and to permit the first and second outputs to settle into respective determinable logic states based on random process variations of elements of the metastable logic, wherein the metastable logic comprises first and second logic gates configured as a locked latch; and
first and second voltage control circuits configured to control supply voltages of transistors of respective ones of the first and second logic gates.

11. The integrated circuit device of claim 10, wherein the first voltage control circuit comprises a first bank of selectable resistors, wherein the second voltage control circuit comprises a second bank of selectable resistors, and wherein the PUF circuit further comprises:
a selector circuit configured to select resistors of the first and second banks of selectable resistors based on respective first and second multi-bit words.

12. The integrated circuit device of claim 11, wherein the first and second voltage control circuits further comprise source degeneration resistors configured to alter effects of random process variations of the transistors of the first and second logic gates.

13. The integrated circuit device of claim 11, wherein the PUF circuit further comprises:
a switch having terminals coupled to the first and second outputs; and
a switch control circuit configured to close the switch for a delay period when the metastable logic is activated, and to open the switch subsequent to the delay period.

14. The integrated circuit device of claim 10, further comprising:
additional PUF circuits; and
a signature generator circuit configured to generate a signature of the integrated circuit device based on an output of the PUF circuit and outputs of the additional PUF circuits.

15. A method, comprising:
activating metastable logic of a physical unclonable function (PUF) circuit to generate metastable states at first and second outputs of the metastable logic;
coupling the first and second outputs to one another for a delay period to retain the first and second outputs at the metastable states for the delay period; and
de-coupling the first and second outputs from one another subsequent to the delay period and permitting the first and second outputs to settle into respective logic states based on random process variations of elements of the metastable logic; and
outputting a PUF logic state based on the logic state of one or more of the first and second outputs of the metastable logic.

16. The method of claim 15, wherein the PUF circuit comprises a first NAND gate configured to receive the first output and an enable control, wherein the PUF circuit further comprises a second NAND gate configured to receive the second output and the enable control, the method further comprising:
activating and deactivating the enable control during the delay period; and
activating the enable control subsequent to the delay period to provide the PUF logic state.

17. The method of claim 15, wherein the metastable logic comprises first and second logic gates configured as a locked latch, and wherein the PUF circuit comprises first and second banks of source degeneration resistors configured to control supply voltages of transistors of respective ones of the first and second logic gates.

18. The method of claim 17, further comprising:
enabling a first number of the source degeneration resistors of each of the first and second banks to provide a first PUF logic state;
generating a first signature based on the first PUF logic state and PUF logic states of other PUF circuits;
enabling a second number of the source degeneration resistors of each of the first and second banks to provide a second PUF logic state that differs from the first PUF logic state; and
generating a second signature based on the second PUF logic state and the PUF logic states of the other PUF circuits.

19. The method of claim 17, further comprising:
incrementally enabling the source degeneration resistors of the first bank while maintaining a constant number of enabled source degeneration resistors of the first bank; and
determining whether the PUF circuit is stable based on the PUF logic state during the incrementally enabling.

20. The method of claim 17, further comprising:
disabling the first and second banks of source degeneration resistors subsequent to the outputting the PUF logic state.
